(19) United States
(12) Patent Application Publication
(10) Pub. No.: US 2015/0163498 A1
(43) Pub. Date: Jun. 11, 2015

(54) VIDEO ENCODING APPARATUS AND VIDEO ENCODING METHOD

(71) Applicant: FUJITSU LIMITED, Kawasaki-shi (JP)

(72) Inventor: Satoshi SHIMADA, Kawasaki (JP)

(21) Appl. No.: 14/560,733

(22) Filed: Dec. 4, 2014

(30) Foreign Application Priority Data
Dec. 6, 2013 (JP) 2013-253514

(51) Int. Cl. H04N 19/18; H04N 19/86; H04N 19/154; H04N 19/117

(52) U.S. Cl. CPC H04N 19/18; H04N 19/117; H04N 19/86; H04N 19/154

(57) ABSTRACT

In a video encoding apparatus, when all of quantized orthogonal transform coefficients in a first sub-block to be encoded first in a block row are zero in value, a transform unit that minimizes degradation of picture quality of the reproduced first sub-block or minimizes an increase in the amount of coding of the first sub-block is selected from among a plurality of transform units included in the first sub-block, and the value of the quantized orthogonal transform coefficient of the selected transform unit is replaced by a predetermined nonzero value so that the quantization parameter of a sub-block preceding the first sub-block will not be referred to when determining the strength of a blocking filter.

### CROSS-REFERENCE TO RELATED APPLICATION

This application is based upon and claims the benefit of priority of the prior Japanese Patent Application No. 2013-253514, filed on Dec. 6, 2013, the entire contents of which are incorporated herein by reference.

### FIELD

The embodiments discussed herein are related to a video encoding apparatus, a video encoding method, and a video encoding computer program.

### BACKGROUND

Generally, the amount of data used to represent video data is very large. Accordingly, an apparatus handling such video data compresses the video data by encoding before transmitting the video data to another apparatus or before storing the video data in a storage device. Typical video coding standards widely used today include the Moving PICTURE Experts Group Phase 2 (MPEG-2), MPEG-4, and H.264 MPEG-4 Advanced Video Coding (H.264 MPEG-4 AVC) defined by the International Standardization Organization/International Electrotechnical Commission (ISO/IEC) (for example, refer to ISO/IEC 14496-10 (MPEG-4 Part 10)/ITU-T Rec. H.264).

These video coding standards achieve data compression by combining such processes as motion search, an orthogonal transform process such as a discrete cosine transform, and entropy coding. Accordingly, the amount of computation needed for encoding video data becomes enormous. In particular, in the case of the High Efficiency Video Coding (HEVC) (refer to ISO/IEC 23008-2/ITU-T H.265) jointly standardized by ISO/IEC and ITU-T, compression efficiency nearly two times as high as that of the H.264/MPEG-4 AVC can be achieved but, compared with the H.264/MPEG-4 AVC, the amount of computation needed for encoding video data further increases. Therefore, if the video coding processes are to be performed using processors having low clock frequencies, it will be advantageous to employ parallel processing in which video data is divided into a plurality of sub-data (for example, each picture contained in video data is divided into a plurality of slices) and encoding is performed on a sub-data-by-sub-data basis.

Video coding reduces the amount of information for video data by exploiting temporal or spatial correlation; to accomplish this, information concerning an already encoded block adjacent to the current block, for example, is used when encoding the current block. In order to enable the plurality of blocks of the video data to be encoded in parallel fashion, some video coding standards provide a method for dividing each picture into regions referred to as slices as a method for resolving dependencies between the blocks. It is provided that any given slice be encoded without referring to the information of any other slice. Since there are no dependencies between the slices, the video encoding apparatus can encode the slices in parallel fashion.

However, when encoding a block belonging to any given slice, the video encoding apparatus is unable to exploit the correlation between the blocks belonging to a slice different from that given slice, and the coding efficiency thus drops. On the other hand, a study has been developed on encoding video data in parallel fashion on a macro-block row basis. When encoding the data in parallel fashion on a block row basis, the start of encoding is delayed for a row located at a lower position so that the video encoding apparatus can utilize the information of the already encoded block adjacent above the block currently being encoded. Since each picture need not be divided into slices, the video encoding apparatus can encode the sub-data of the video data in parallel fashion while preventing degradation of the coding efficiency.

However, the predicted value of the quantization parameter (QP) used to control the quantization to be applied to the orthogonal transform coefficients obtained by orthogonal-transforming the prediction error signal of the block to be encoded is generated by referring to the QP of the block immediately preceding in raster scan order. This means that the predicted value of the QP for the first block in each of the second and subsequent block rows is generated by referring to the QP of the last block in the block row directly above the current block. Accordingly, with the method that shifts the horizontal position of the block to be encoded from one block row to the next, it is at least not possible to completely resolve the QP-related dependency.

In order to reduce blocking artifacts arising from quantization errors, some video coding schemes apply a deblocking filter to the decoded picture to reduce the blocking artifacts. Since the amount of picture distortion due to compression varies depending on the QP, as described above, the strength of the deblocking filter is adjusted based on the QP. For example, in H.264, the strength of the deblocking filter for a given macro-block is determined based on the average value taken between the QP of the given macro-block and the QP of its adjacent macro-block. However, in the syntax of H.264, if the prediction mode for the macro-block is not the intra-prediction mode based on a 16×16 pixel block size, and if the flag indicating the presence of a nonzero orthogonal transform coefficient is set to 0, then the QP of the macro-block is not contained in the encoded data. In this case, the strength of the deblocking filter is determined, not using the QP of that macro-block, but using the QP of the immediately preceding macro-block. Suppose that when encoding video data in parallel fashion on a macro-block row basis, as described above, all the orthogonal transform coefficients of the attention macro-block located at the head of a given macro-block row are zero in value. In this case, the video encoding/decoding apparatus is unable to determine the strength of the deblocking filter for the attention macro-block until the encoding of the last macro-block in the immediately preceding macro-block row is completed. In view of this, there is proposed a video encoding apparatus which, when all the transform coefficients obtained by orthogonal-transforming a given block are zero in value, changes at least one of the transform coefficients to a nonzero coefficient (for example, refer to Japanese Laid-open Patent Publication No. 2007-251758).

### SUMMARY

In HEVC, each picture contained in video data is divided into blocks in a number of steps. FIG. 1 is a diagram illustrating one example of how a picture is divided according to HEVC.

As illustrated in FIG. 1, the picture 100 is divided into basic processing units referred to as Coding Tree Units (CTUs); the CTUs 101 are encoded in raster scan order. The size of the CTU 101 is selectable from among sizes of 64×64 to 16×16 pixels.

Each CTU 101 is further divided into a plurality of Coding Units (CUs) 102 using a quadtree structure. The CUs 102 in each CTU 101 are encoded in Z scan order. The size of the CU 102 is variable and is selected from among CU partitioning modes of 8×8 to 64×64 pixels. The CU 102 is the unit at which a decision is made as to whether to employ the intra-predictive coding mode or the inter-predictive coding mode as the coding mode. Each CU 102 is partitioned into Prediction Units (PUs) 103 or Transform Units (TUs) 104 for processing. The PU 103 is the unit at which the prediction is performed in accordance with the selected coding mode. For example, in the intra-predictive coding mode, the PU 103 is the unit at which the prediction mode is applied and, in the inter-predictive coding mode, the PU 103 is the unit at which motion compensation is performed. The size of the PU 103 is selectable from among PU partitioning modes PartMode=2N×2N, N×N, 2N×N, N×2N, 2N×U, 2N×nD, nR×2N, and nL×2N. On the other hand, the TU 104 is the orthogonal transform unit, and a discrete cosine transform (DCT) or a discrete sine transform (DST) is performed at the TU level. The size of the TU 104 is selected from among sizes of 4×4 to 32×32 pixels. The TUs 104 are formed by partitioning using a quadtree structure and are processed in Z scan order.

In HEVC, QP is encoded using a grid referred to as Quantization Group (QG) as the minimum unit. In other words, the video encoding apparatus can change QP only once for each QG.

When encoding QP, the video encoding apparatus encodes the difference between the QP and its predicted value QPpred, i.e., cuQpDelta=QP−QPpred. When all the quantized transform orthogonal coefficients within a given CU contained in the QG are zero in value, the coefficients obtained by inverse quantization are given as dᵢⱼ=0, regardless of the value of the QP. Therefore, in this case, the video encoding apparatus does not encode cuQpDelta. For any CU in the QG in which a nonzero quantized orthogonal transform coefficient appears, cuQpDelta is communicated to the video decoding apparatus. On the other hand, for any CU in which cuQpDelta has not been encoded, the video decoding apparatus determines that QP=QPpred by assuming that cuQpDelta=0. When all the quantized transform orthogonal coefficients are zero in value, QP is not used for inverse quantization, but QP is used for determining the strength of the deblocking filter. The video encoding apparatus, which generates the same local decoded image as the video decoding apparatus, quantizes the current CU as QP=QPa and, if all the resulting coefficients are zero in value, the video encoding apparatus does not encode cuQpDelta, and determines the strength of the deblocking filter by setting the QP of that CU equal to QPpred in the same manner as the video decoding apparatus.

The value of QPpred is common to all the CUs contained in the same QG. QPpred is calculated from QPprev which is the QP of the QG immediately preceding the current QG, QPabove which is the QP of the QG adjacent above the current QG, and QPleft which is the QP of the QG adjacent on the left side of the current QG. In HEVC, QPabove and QPleft are not to be referred to across CTU boundaries.

As described above, QP is determined for each QG containing a plurality of CUs, but each CU may be partitioned into a plurality of TUs. As a result, when encoding each picture by processing CTU rows in parallel fashion in accordance with HEVC, if the bottleneck associated with the setting of the deblocking filter strength is to be resolved by using the technique disclosed in Japanese Laid-open Patent Publication No. 2007-251758, the question is which TU is to be selected as the TU whose orthogonal transform coefficient is to be corrected when all the orthogonal transform coefficients within the CU are zero in value.

Further, according to the technique disclosed in Japanese Laid-open Patent Publication No. 2007-251758, the value of the QP to be applied to a block in which any one of the orthogonal transform coefficients is corrected to a nonzero coefficient is set so that all the prediction error signals obtained by inverse-quantizing and inverse-transforming the quantized orthogonal transform coefficients of that block become zero in order to prevent picture quality degradation. As a result, the QP value is restricted to a very small value. Since the difference between the QP value and the predicted QP value becomes large because of this restriction, the amount of coding for cuQpDelta increases. Furthermore, the QP is determined for each QG containing a plurality of CUs, as described above; therefore, in the case of a QG for which the QP value is set to a very small value, the absolute values of the quantized orthogonal transform coefficients of each CU contained in the QG do not become small enough, and the coding efficiency thus drops.

According to one embodiment, a video encoding apparatus which divides a picture contained in video data into a plurality of blocks and encodes the picture on a block-row-by-block-row basis is provided. The video encoding apparatus includes: an orthogonal transform unit which, for each of a plurality of sub-blocks formed by partitioning each of the blocks, calculates an orthogonal transform coefficient by orthogonal-transforming a prediction error signal taken between the sub-block and a prediction block corresponding to the sub-block for each of transform units formed by partitioning the sub-block; a quantizing unit which, for each of the plurality of sub-blocks, calculates a quantized orthogonal transform coefficient by quantizing the orthogonal transform coefficient in accordance with a first quantization parameter that defines a quantization step size; an inverse quantizing unit which, for each of the plurality of sub-blocks, reconstructs the orthogonal transform coefficient by inverse-quantizing the quantized orthogonal transform coefficient by using the first quantization parameter; an inverse orthogonal transform unit which, for each of the plurality of sub-blocks, reconstructs the prediction error signal by inverse-orthogonal transforming the reconstructed orthogonal transform coefficient; an adder unit which, for each of the plurality of sub-blocks, reproduces the sub-block by adding each reconstructed prediction error signal to the value of the corresponding pixel of the corresponding prediction block; a deblocking filter unit which, for each reproduced sub-block, when all the quantized orthogonal transform coefficients for the sub-block are zero in value, determines deblocking filter strength based on the first quantization parameter determined for another sub-block already encoded but, when any of the quantized orthogonal transform coefficients for the sub-block is nonzero in value, determines the deblocking filter strength based on the first quantization parameter determined for the sub-block, and applies deblocking filtering with the determined strength; and a coefficient correcting unit which, when all the quantized orthogonal transform coefficients in a first sub-block of the plurality of sub-blocks that is to be encoded first in a row of the blocks are zero in value, selects from among the transform units contained in the first sub-block the transform unit that minimizes degradation of picture quality of the reproduced first sub-block or minimizes an increase in the amount of coding of the first sub-block, and replaces the value of the quantized orthogonal transform coefficient of the selected transform unit by a predetermined nonzero value.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating one example of how a picture is divided according to HEVC.

FIG. 2 is a diagram illustrating schematically the configuration of a video encoding apparatus according to one embodiment.

FIG. 3 is a diagram illustrating the relationship between encoding units and CTU rows.

FIG. 4 is a diagram illustrating the configuration of the encoding unit.

FIGS. 5A to 5F are diagrams each depicting an example of a Scaling List.

FIG. 6 is a diagram illustrating the configuration of a coefficient correcting unit.

FIG. 7 is an operation flowchart illustrating a coefficient correction process.

FIG. 8 is an operation flowchart illustrating a video encoding process.

FIG. 9 is a diagram illustrating the configuration of a coefficient correcting unit according to a second embodiment.

FIG. 10 is a conceptual diagram illustrating a coefficient correction process according to the second embodiment.

FIG. 11 is an operation flowchart illustrating the coefficient correction process according to the second embodiment.

FIG. 12 is a diagram illustrating the configuration of a computer that operates as the video encoding apparatus by executing a computer program for implementing the functions of the various units constituting the video encoding apparatus according to each of the above embodiments or their modified examples.

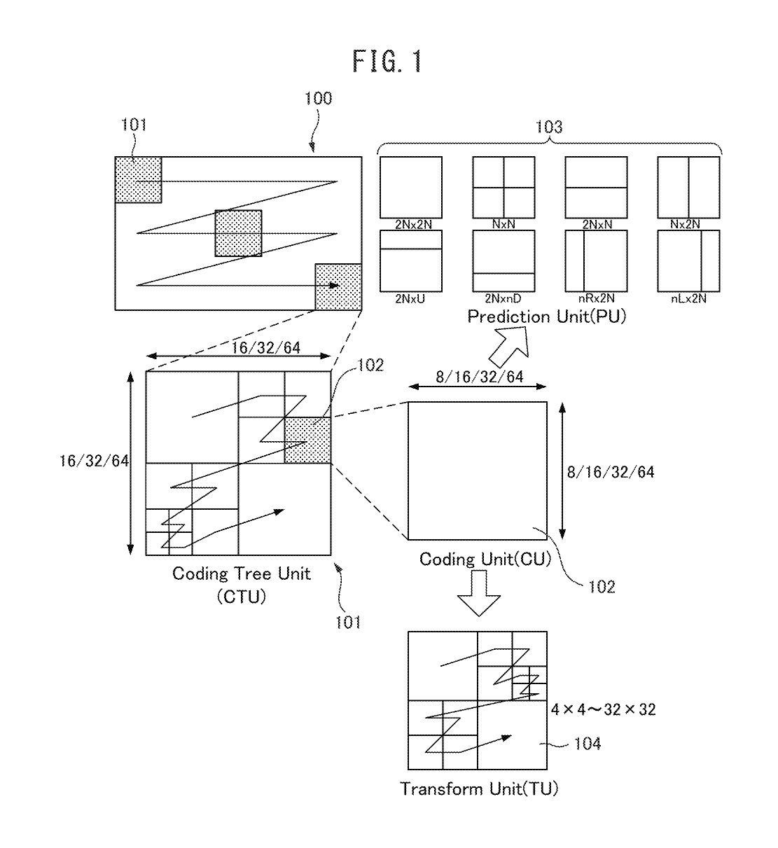

### DESCRIPTION OF EMBODIMENTS

A video encoding apparatus according to one embodiment will be described below with reference to the drawings. The video encoding apparatus of the embodiment encodes video data by processing rows of CTUs as basic processing units in parallel fashion in accordance with a coding scheme, such as HEVC, that can encode each picture contained in the video data by dividing the picture into blocks in a number of steps. According to the video encoding apparatus, if all the quantized orthogonal transform coefficients contained in the CU to be encoded first in a given CTU row are zero in value, the value of one of the quantized orthogonal transform coefficients of the TUs contained in the CU is corrected to a predetermined nonzero value. The video encoding apparatus can process the CTU rows in parallel fashion while preventing mutual reference between the CTU rows from occurring when determining the deblocking filter strength.

Furthermore, according to the video encoding apparatus, the TU whose quantized orthogonal transform coefficient is to be corrected is selected so as to be able to minimize quality degradation of the reproduced picture. Further, according to the video encoding apparatus, the corrected QP value to be applied to the QG containing the TU is set to a value close to the QP value used to quantize the TU, thereby preventing the amount of coding from increasing.

The picture may be either a frame or a field. A frame refers to one complete still image contained in video data, while a field refers to a still image obtained by extracting data only in the odd-numbered lines or even-numbered lines from one frame.

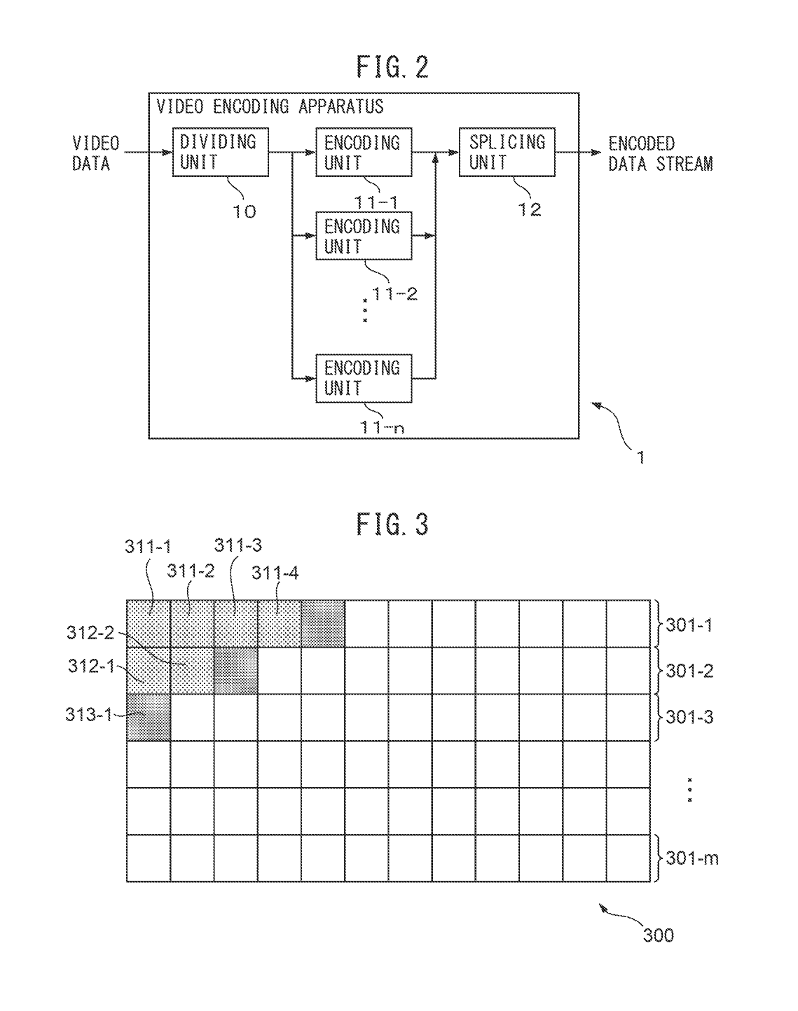

FIG. 2 is a diagram illustrating schematically the configuration of the video encoding apparatus according to the one embodiment. The video encoding apparatus 1 includes a dividing unit 10, a number, n, of encoding units 11-1 to 11-n (where n is an integer not smaller than 2), and a splicing unit 12. These units constituting the video encoding apparatus 1 are implemented as separate circuits. Alternatively, these units constituting the video encoding apparatus 1 may be implemented in the form of a single integrated circuit on which the circuits corresponding to the respective units are integrated. Further alternatively, these units constituting the video encoding apparatus 1 may be implemented as functional modules by executing a computer program on a processor incorporated in the video encoding apparatus 1.

The dividing unit 10 divides each picture contained in the video data into rows of CTUs, each row containing CTUs arranged in a horizontal direction. Then, the dividing unit 10 supplies data of each CTU row to a designated one of the encoding units 11-1 to 11-n.

The encoding units 11-1 to 11-n encode the CTUs contained in the respectively received CTU rows. When the number of encoding units is larger than or equal to the number of CTU rows, each encoding unit may encode one CTU row. When the number of encoding units is smaller than the number of CTU rows, the encoding units, for example, encode n CTU rows, respectively, starting from the top CTU row. For example, let the CTU rows contained in one picture be denoted by CTU row 1, CTU row 2, . . . , CTU row m (where m>n), respectively, from top to bottom. In this case, the encoding units 11-1 to 11-n first encode the CTU rows 1 to n, respectively. Then, the encoding units 11-1 to 11-n encode the CTU rows (n+1) to (2n), respectively. Then, the encoding units 11-1 to 11-n encode the next n rows, the process being repeated until the encoding of the bottom CTU row m is completed.

FIG. 3 is a diagram illustrating the relationship between the encoding units and the CTU rows. The picture 300 is divided into a number, m, of CTU rows 301-1 to 301-m. For example, the CTU row 301-1 is encoded by the encoding unit 11-1, the CTU row 301-2 is encoded by the encoding unit 11-2, and the CTU row 301-3 is encoded by the encoding unit 11-3.

From the standpoint of coding efficiency, it is preferable that, when encoding the CTU row 301-2 and subsequent CTU rows, each corresponding encoding unit can refer to information of already encoded CTUs in the immediately preceding CTU row. For example, it is preferable that, when encoding a given CTU, the encoding unit can refer to the information of the CTU adjacent above the given CTU and the information of the CTU adjacent to the upper right of the given CTU. It is therefore preferable that each encoding unit starts encoding after the encoding unit encoding the immediately preceding CTU row has completed the encoding of the two leftmost CTUs in the CTU row. Accordingly, it is preferable that, by the time the encoding unit 11-3 starts to encode the first CTU 313-1 in the third CTU row 301-3 from the top, the encoding unit 11-2 has already completed the encoding of the first and second CTUs 312-1 and 312-2 in the second CTU row 301-2 from the top. Likewise, it is preferable that, by that time, the encoding unit 11-1 has already completed the encoding of the first to fourth CTUs 311-1 to 311-4 in the top CTU row 301-1.

The encoding units 11-1 to 11-n supply the data streams of the encoded CTU rows to the splicing unit 12.

Based on the data streams of the encoded CTU rows, the splicing unit 12 splices the encoded data of the CTUs in raster scan order starting with the encoded data of the CTUs contained in the top CTU row. Then, the splicing unit 12 entropy-codes various encoded data contained in the data streams in such a manner that signal values with higher probability of occurring are represented by shorter codewords. The splicing unit 12 can use, for example, Huffman coding such as CAVLC or arithmetic coding such as CABAC as the method of entropy coding.

The splicing unit 12 generates an encoded data stream of the picture by appending header information, etc. in accordance with a prescribed encoded data format to the data stream generated by the entropy coding. Then, the splicing unit 12 splices the encoded data streams of successive pictures in accordance with the encoding order of the pictures. Subsequently, the splicing unit 12 generates an encoded video data stream by appending header information, etc. in accordance with a prescribed encoded data format to the spliced data stream, and outputs the encoded video data stream.

Next, the details of the encoding units 11-1 to 11-n will be described below. Since the encoding units 11-1 to 11-n are identical in configuration and function, the following description deals only with one encoding unit.

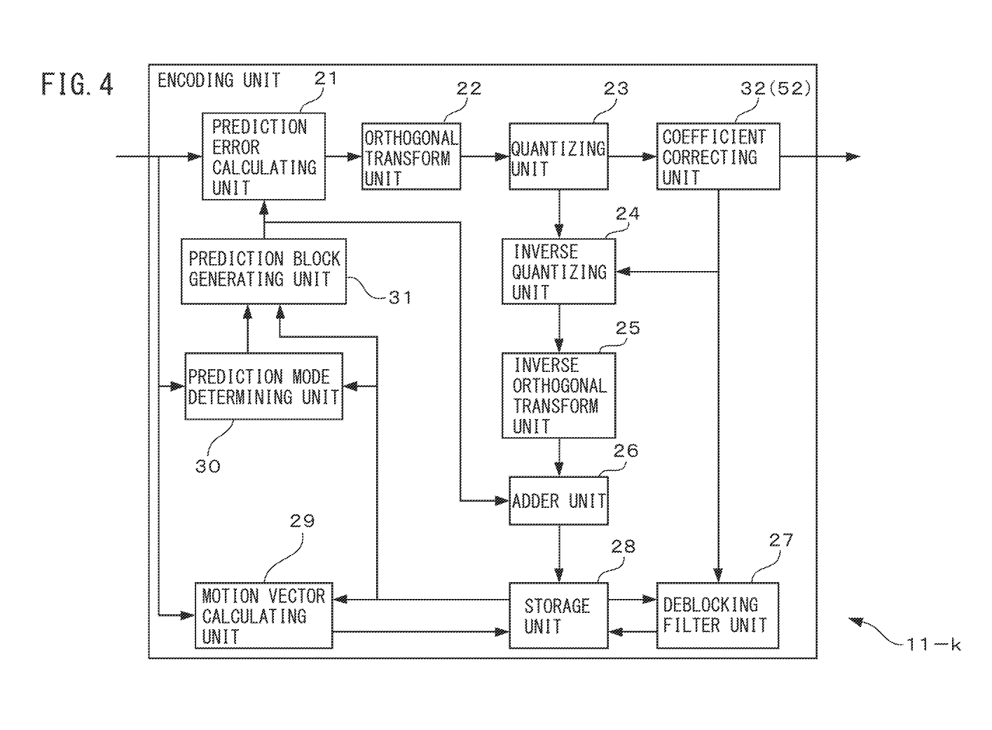

FIG. 4 is a diagram illustrating the configuration of the encoding unit 11-k (k=1, 2, . . . , n). The encoding unit 11-k includes a prediction error calculating unit 21, an orthogonal transform unit 22, a quantizing unit 23, an inverse quantizing unit 24, an inverse orthogonal transform unit 25, an adder unit 26, a deblocking filter unit 27, a storage unit 28, a motion vector calculating unit 29, a prediction mode determining unit 30, a prediction block generating unit 31, and a coefficient correcting unit 32.

The encoding unit 11-k performs encoding on a CTU-by-CTU basis starting with the first CTU (in the illustrated example, the leftmost CTU) contained in the CTU row data received from the dividing unit 10.

For each CU contained in the current CTU to be encoded, the prediction error calculating unit 21 calculates the difference relative to the prediction block generated by the prediction block generating unit 31 for each TU contained in the CU. Then, the prediction error calculating unit 21 takes as the prediction error signal of the TU the difference value obtained by the difference calculation for each pixel in the TU.

Based on the TU partitioning information communicated from the prediction mode determining unit 30 to indicate the TU partitioning pattern, the orthogonal transform unit 22 orthogonal-transforms the prediction error signal of each TU contained in the CU and thereby obtains orthogonal transform coefficients representing the frequency components in both horizontal and vertical directions. For example, the orthogonal transform unit 22 obtains DCT coefficients as the orthogonal transform coefficients by performing DCT as the orthogonal transform process.

The quantizing unit 23 calculates quantized orthogonal transform coefficients by quantizing the orthogonal transform coefficients obtained for each TU by the orthogonal transform unit 22. The quantization is a process for representing the signal values contained within a given section (quantization step) by one signal value. The quantizing unit 23 quantizes the orthogonal transform coefficients with the quantization step size that is determined by using as parameters the quantization step Qstep(QP) determined based on the earlier described QP and a matrix ScalingList for adjusting the weights to be applied to the quantized transform coefficients on a frequency-by-frequency basis. The QP value is determined, for example, by a control unit (not depicted) in accordance with the amount of coding set for the CU, and is supplied from the control unit. For example, when the orthogonal transform coefficient for the component in the ith row and jth column is denoted by cᵢⱼ, the quantizing unit 23 calculates the quantized orthogonal transform coefficient for the orthogonal transform coefficient cᵢⱼ in accordance with the following equation.

c′ᵢⱼ=Sign(cᵢⱼ)·Round(Abs(cᵢⱼ)·16/{Qstep(QP)·ScalingList(i,j)})>>(a−log 2(TUSize)) (1)

a: fixed value (for example, 7)

where Round( ) indicates an operation for rounding to an integer, and Abs( ) is a function that outputs an absolute value. Sign( ) is a function that outputs a positive/negative sign. TUSize indicates the number of pixels horizontally or vertically in the TU. The operator “a>>b” is a shift operator for shifting the parameter “a” by “b” bits in the low-order direction. Qstep(QP) is expressed by the following equation.

Qstep(QP)=2^{{(QP-12)/6}} (2)

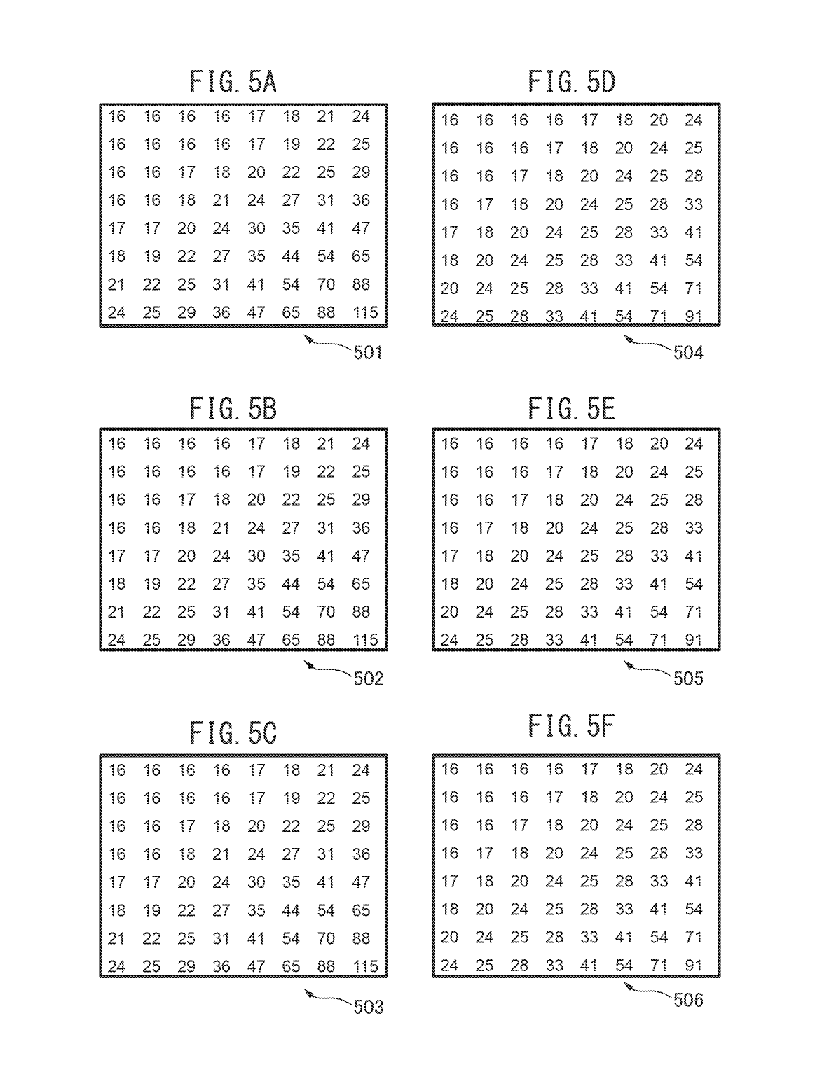

FIGS. 5A to 5F are diagrams each depicting an example of ScalingList. In each of FIGS. 5A to 5F, the value in the upper left corner represents the scaling value corresponding to the DC component. The ScalingLists 501 to 503 depicted in FIGS. 5A to 5C are the matrices applied to the TU in the case of intra-predictive coding for the sizes of 8×8 pixels, 16×16 pixels, and 32×32 pixels, respectively. On the other hand, the ScalingLists 504 to 506 depicted in FIGS. 5D to 5F are the matrices applied to the TU in the case of inter-predictive coding for the sizes of 8×8 pixels, 16×16 pixels, and 32×32 pixels, respectively. In the ScalingLists 502 and 505 depicted in FIGS. 5B and 5E, one element is applied to 2×2=4 components. Likewise, in the ScalingLists 503 and 506 depicted in FIGS. 5C and 5F, one element is applied to 4×4=16 components.

For each TU size, a ScalingList in which all the elements have the same value (for example, 16) may be used. For example, when the TU has a size of 4×4 pixels, each element in the ScalingList is 16, for both of the intra-predictive coding mode and the inter-predictive coding mode. The ScalingList each of whose elements has a value of 16 is used as the initial value in the standard.

Since the frequency at which the orthogonal transform coefficient cᵢⱼ has a value close to zero increases as a result of the shift operation, it becomes easier for the splicing unit 12 to compress the amount of coding by entropy coding.

The quantizing unit 23 passes the quantized orthogonal transform coefficients and the TU partitioning information indicating how the CU is partitioned into TUs to the inverse quantizing unit 24 and the coefficient correcting unit 32.

The inverse quantizing unit 24, the inverse orthogonal transform unit 25, the adder unit 26, and the deblocking filter unit 27 work cooperatively to generate from the quantized orthogonal transform coefficients of each TU a reference block which is referred to when encoding a CU, etc. after the TU, and the generated reference block is stored in the storage unit 28.

To that end, the inverse quantizing unit 24 inverse-quantizes the quantized orthogonal transform coefficients of each TU. For example, the inverse quantizing unit 24 reconstructs each orthogonal transform coefficient dᵢⱼ in accordance with the following equation.

dᵢⱼ=c′ᵢⱼ·{Qstep(QP)·ScalingList(i,j)<<(a−log 2(TUSize))}/16 (3)

where the operator “a<<b” is a shift operator for shifting the parameter “a” by “b” bits in the high-order direction. The inverse quantizing unit 24 supplies the reconstructed orthogonal transform coefficients of each TU to the inverse orthogonal transform unit 25.

The inverse orthogonal transform unit 25 applies an inverse orthogonal transform to the reconstructed orthogonal transform coefficients on a TU-by-TU basis. For example, when the DCT is used as the orthogonal transform by the orthogonal transform unit 22, the inverse orthogonal transform unit 25 applies an inverse DCT as the inverse orthogonal transform. In this way, for each TU, the inverse orthogonal transform unit 25 reconstructs the prediction error signal having approximately the same information as the original prediction error signal. The inverse orthogonal transform unit 25 supplies the prediction error signal reconstructed on a TU-by-TU basis to the adder unit 26.

The adder unit 26 adds the prediction error signal reconstructed for each TU to each pixel value of the prediction block for the TU, and thereby generates a reference block which is used to generate a prediction block for a CU, etc. to be encoded thereafter. Each time a reference block is generated, the adder unit 26 stores the reference block in the storage unit 28.

The storage unit 28 temporarily stores the reference block received from the adder unit 26. A reference picture is obtained by splicing the reference blocks for one picture in accordance with the encoding order of the TUs. Therefore, the storage unit 28 may receive from other encoding units the data of reference blocks of other CTU rows generated for an already encoded picture. The storage unit 28 supplies the reference picture or reference block to the motion vector calculating unit 29, the prediction mode determining unit 30, and the prediction block generating unit 31. The storage unit 28 stores a predetermined number of reference pictures which the picture to be encoded may refer to; then, as the number of reference pictures exceeds the predetermined number, the reference pictures are discarded in the same order as they were encoded. Further, the storage unit 28 stores a motion vector for each of the inter-predictive coded reference blocks.

The deblocking filter unit 27, in order to reduce blocking artifacts, applies a deblocking filter to the reference blocks stored in the storage unit 28 across the boundary between two adjacent reference blocks, and thereby smoothes the pixel values of each reference block. The deblocking filter unit 27 may apply other filtering operation, such as a sample adaptive offset filter, to the reference blocks. The deblocking filter unit 27 stores the filtered reference blocks in the storage unit 28.

The deblocking filter unit 27 determines the strength of the deblocking filter, for example, in accordance with the HEVC standard. In other words, for a CU for which one or more of the quantized orthogonal transform coefficients are nonzero in value, i.e., for a CU for which the QP value is to be encoded, the deblocking filter unit 27 determines the strength of the deblocking filter based on the QP value of the CU itself. On the other hand, for a CU for which all the quantized orthogonal transform coefficients are zero in value, the deblocking filter unit 27 determines the strength of the deblocking filter based on the QP value of another CU already encoded. Further, as will be described later, for a CU for which any one of the quantized orthogonal transform coefficients has been corrected by the coefficient correcting unit 28, the deblocking filter unit 27 determines the strength of the deblocking filter in accordance, for example, with the HEVC standard, based on a second QP value that has been set by the coefficient correcting unit 28.

The motion vector calculating unit 29 calculates a motion vector for each PU in the current CU by using the PU and the reference picture in order to generate the prediction block for inter-predictive coding. The motion vector represents the amount of spatial displacement between the PU and the region within the reference picture that most closely matches the PU.

By performing block matching between the PU and the reference picture, the motion vector calculating unit 29 determines the location of the region in the reference picture that best matches the PU. Then, the motion vector calculating unit 29 obtains the motion vector by calculating the amount of horizontal and vertical displacements between the location of the PU in the current picture and the location of the region in the reference picture that best matches the PU. The motion vector calculating unit 29 passes the motion vector obtained and the identification information of the reference picture to the storage unit 28, the prediction mode determining unit 30, the prediction block generating unit 31, and the prediction error calculating unit 21.

The prediction mode determining unit 30 determines the CU size, PU size, and TU size to which the CTU to be encoded is to be divided, and the method of generating the prediction block. The prediction mode determining unit 30 determines the predictive coding mode for the CTU, based on the information acquired from a control unit (not depicted) and indicating the type of the picture containing the CU to be encoded. IF the picture to be encoded is an I-picture, the prediction mode determining unit 30 selects the intra-predictive coding mode as the predictive coding mode to be applied to it. On the other hand, if the picture to be encoded is a P-picture or a B-picture, the prediction mode determining unit 30 selects either the inter-predictive coding mode or the intra-predictive coding mode, for example, as the predictive coding mode to be applied to it.

The prediction mode determining unit 30 calculates on a CU-by-CU basis the cost that represents the evaluation score of the amount of encoded data of the CTU for each applicable predictive coding mode. For example, in the case of the inter-predictive coding mode, the prediction mode determining unit 30 calculates the cost for each possible combination of the CU size, PU size, and TU size to which to the CTU it to divided and the vector mode that defines the prediction vector generation method for the motion vector. On the other hand, in the case of the intra-predictive coding mode, the prediction mode determining unit 30 calculates the cost for each possible combination of the CU size, PU size, and TU size to which the CTU is to be divided and the prediction mode that defines the prediction block generation method. Then, the prediction mode determining unit 30 selects the intra-predictive coding mode or the inter-predictive coding mode for each CU within the CTU so as to minimize the cost. Further, the prediction mode determining unit 30 selects the prediction mode or vector mode that minimizes the cost for each combination of PUs and TUs within each CU.

The prediction mode determining unit 30 notifies the prediction block generating unit 31 of the selected combination of the CU size, PU size, TU size, and the prediction block generation method. Further, the prediction mode determining unit 30 passes the TU partitioning information to the orthogonal transform unit 22, the quantizing unit 23, the inverse quantizing unit 24, the inverse orthogonal transform unit 25, and the coefficient correcting unit 32.

The prediction block generating unit 31 generates the prediction block of each TU in accordance with the combination of the CU size, PU size, TU size, and the prediction block generation method selected by the prediction mode determining unit 30. For example, when the CU is to be inter-predictive coded, the prediction block generating unit 31 applies motion compensation to the reference picture obtained from the storage unit 28 for each PU in the CU, based on the motion vector supplied from the motion vector calculating unit 29. Then, the prediction block generating unit 14 generates the motion-compensated prediction block for inter-predictive coding.

On the other hand, when the current CU is to be intra-predictive coded, the prediction block generating unit 31 generates the prediction block of each TU by applying the prediction mode selected for each PU in the CU. The prediction block generating unit 31 passes the generated prediction block to the prediction error calculating unit 21.

The coefficient correcting unit 32 determines whether all the quantized orthogonal transform coefficients in the CU to be encoded first in the CTU row are zero in value or not. If all the quantized orthogonal transform coefficients in the CU to be encoded first in the CTU row are zero in value, the coefficient correcting unit 32 corrects the value of one of the quantized orthogonal transform coefficients of the TUs contained in the CU to a predetermined nonzero value, and determines the QP value so that any degradation of the picture quality does not occur due to the correction. Then, the coefficient correcting unit 32 supplies the quantized orthogonal transform coefficients of each CU as the encoded data to the splicing unit 12. The details of the coefficient correcting unit 32 will be described hereinafter.

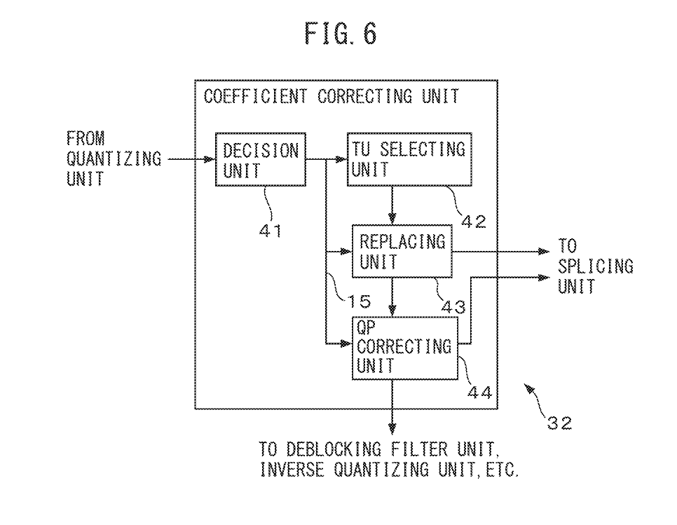

The details of the coefficient correcting unit 32 will be described below. FIG. 6 is a diagram illustrating the configuration of the coefficient correcting unit 32. The coefficient correcting unit 32 includes a decision unit 41, a TU selecting unit 42, a replacing unit 43, and a QP correcting unit 44.

The decision unit 41 makes a decision as to whether the current CU is the CU to be encoded first in the CTU row. If the current CU is the CU to be encoded first, the decision unit 41 then makes a decision as to whether all the quantized orthogonal transform coefficients within the CU are zero in value or not. If all the quantized orthogonal transform coefficients are zero in value, the decision unit 41 decides that a coefficient correction is to be applied to the current CU.

On the other hand, if the current CU is not the CU to be encoded first in the CTU row, the deblocking filter unit 27 can determine the strength of the deblocking filter for the current CU by referring to the QP value of another CU already encoded within the CTU row. Therefore, in this case, the decision unit 41 decides that a coefficient correction is not to be applied to the current CU. Further, if the value of any one of the quantized orthogonal transform coefficients within the current CU is nonzero, the decision unit 41 decides that a coefficient correction is not to be applied to the current CU, because the deblocking filter unit 27 can use the QP value of the current CU itself.

When it is decided that a coefficient correction is to be applied to the current CU, the TU selecting unit 42 selects, based on the TU partitioning information received from the quantizing unit 23, a TU that contains the quantized orthogonal transform coefficient whose value is to be replaced by a nonzero value. Of the quantized orthogonal transform coefficients, any one of the frequency component coefficients may be selected as the coefficient whose value is to be replaced by a nonzero value but, from the standpoint of reducing the number of bits needed for the entropy coding in the splicing unit 12, it is preferable to select a coefficient representing the DC component (for example, the coefficient (0, 0) in the case of DCT) as the coefficient whose value is to be replaced by a nonzero value. Likewise, while the value of the quantized orthogonal transform coefficient may be replaced by any integer other than 0, it is preferable to replace it by 1 or −1 from the standpoint of reducing the number of bits needed for the entropy coding in the splicing unit 12.

When the value of any one of the quantized orthogonal transform coefficients is changed from 0 to 1, the value of the reconstructed prediction error signal obtained by the inverse quantization and inverse orthogonal transform also changes from 0 to some other value. The difference between the prediction error signal reconstructed when the value of the quantized orthogonal transform coefficient has been replaced and the prediction error signal reconstructed when the value of none of the quantized orthogonal transform coefficients has been replaced can be regarded as noise that occurs as a result of replacing the value of the quantized orthogonal transform coefficient. Therefore, it is preferable for the TU selecting unit 42 to select the TU such that its quantized orthogonal transform coefficient is replaced so as to reduce the noise that occurs as a result of replacing the value of the quantized orthogonal transform coefficient and so as not to affect the quality of the decoded picture.

When the value of the quantized orthogonal transform coefficient of the DC component (i.e., c′₀₀ in equations (1) and (3)) is replaced by 1, the magnitude of the prediction error signal value after the inverse quantization and inverse orthogonal transform is determined by the QP, the size of the TU, and the DC component value scalingListDC in the ScalingList corresponding to the TU. In other words, when all the quantized orthogonal transform coefficients cᵢⱼ within the TU are zero in value, the DC component d₀₀ of the inverse-quantized orthogonal transform coefficient when c′₀₀ is replaced by 1 is calculated in accordance with the equation (3). Then, from d₀₀, the value rᵢⱼ of the prediction error signal reconstructed by the inverse orthogonal transform (in the illustrated example, the inverse DCT) when the DC component is 1 is calculated as follows:

d′₀₀=(d₀₀·64+64)>>7 (4)

rᵢⱼ=(d′₀₀·64+2048)>>12

If the value of the quantized orthogonal transform coefficient of the DC component, c′₀₀, is not replaced, then rᵢⱼ=0; therefore, the TU selecting unit 42 can reduce the noise by selecting the TU such that the value of the quantized orthogonal transform coefficient of the DC component, c′₀₀, is replaced so as to reduce the absolute value of rᵢⱼ. As is apparent from equation (4), the TU selecting unit 42 need only reduce d_{H} in order to reduce rᵢⱼ.

More specifically, the TU selecting unit 42 allocates priority to each TU according to the TU size in such a manner that the priority increases as the absolute value of d₀₀ decreases. Then, from among the TUs within the current CU, the TU selecting unit 42 selects the TU of the TU size having the highest priority as the TU whose quantized orthogonal transform coefficient value is to be replaced.

If the DC component of the ScalingList that may be used for the current CU is the same value regardless of the TU size, the TU selecting unit 42 sets the priority so that the priority increases as the TU size increases, because, as can be seen from equation (3), dᵢⱼ decreases as the TU size increases.

The TU selecting unit 42 selects from among luminance TUs the TU whose quantized orthogonal transform coefficient value is to be replaced. Alternatively, the TU selecting unit 42 may select from among chrominance TUs the TU whose quantized orthogonal transform coefficient value is to be replaced. Further alternative, the TU selecting unit 42 may select from among the luminance TUs and chrominance TUs one TU whose quantized orthogonal transform coefficient value is to be replaced. If there are a plurality of TUs of the size having the highest priority, the TU selecting unit 42 may select the TU contained in a predetermined region within the CU from among the plurality of TUs.

The replacing unit 43 replaces the value of one of the quantized orthogonal transform coefficients of the TU selected by the TU selecting unit 42 from within the current CU by a nonzero value. As earlier described, in the present embodiment, the replacing unit 43 replaces the value of the quantized orthogonal transform coefficient of the DC component by either 1 or −1. After replacing the value of one of the quantized orthogonal transform coefficients, the replacing unit 43 supplies the quantized orthogonal transform coefficients of the current CU as the encoded data to the splicing unit 12.

The QP correcting unit 44 selects the second QP closest to the first QP used to quantize the TUs in the current CU from within the range in which the prediction error signal rᵢⱼ reconstructed for the TU selected by the TU selecting unit 42 becomes zero.

The range in which the reconstructed prediction error signal rᵢⱼ for the TU whose quantized orthogonal transform coefficient value has been replaced becomes zero is determined based on the DC component of the ScalingList. For example, when the ScalingListDC is 16, the range of QP values in which rᵢⱼ becomes zero is obtained from the following table.

TABLE 1
MAPPING TABLE THAT PROVIDES MAPPING BETWEEN
TU SIZE AND RANGE OF QP VALUES
IN WHICH rᵢⱼ BECOMES ZERO

| | |
|---|---|
| INTRA PREDICTION | INTER PREDICTION |

| | QP | | QP |
|---|---|---|---|
| TU SIZE | RANGE | TU SIZE | RANGE |
| 4 × 4 | ≦5 | 4 × 4 | ≦9 |
| 8 × 8 | ≦15 | 8 × 8 | ≦15 |
| 16 × 16 | ≦21 | 16 × 16 | ≦21 |
| 32 × 32 | ≦27 | 32 × 32 | ≦27 |

As can be seen from the above mapping table, the selectable PQ range increases as the TU size increases. Since, in many cases, there is a local spatial correlation within a picture, it is presumed that the first QP of the current CU has a value close to the QP used for the neighboring CUs. Accordingly, the closer the value of the second QP is to the value of the first QP, the smaller the QP difference cuQpDelta between adjacent QGs is, and as a result, the amount of coding for the cuQpDelta is reduced. In view of this, the QP correcting unit 44 refers to the mapping table stored, for example, in a memory circuit (not depicted) included within the QP correcting unit 44, and obtains the QP range in which rᵢⱼ becomes zero for the TU size selected by the TU selecting unit 42. Then, the QP correcting unit 44 determines the second QP by selecting from within the QP range a QP value that is closest to the first QP value communicated from the quantizing unit 23.

In the present embodiment, since the TU whose quantized orthogonal transform coefficient value is to be replaced is selected so as to increase the TU size, i.e., so as to increase the selectable QP range, it becomes easier for the QP correcting unit 44 to select a value close to the first QP as the second QP. As a result, the video encoding apparatus 1 can reduce the amount of coding for the cuQpDelta.

If the noise that occurs as a result of replacing the value of the quantized orthogonal transform coefficient is allowed, then the QP correcting unit 44 may set the second QP value by selecting a value that falls outside the QP value range determined in accordance with the TU size. In this case, even if the first QP value lies outside the range, the QP correcting unit 44 can set the second QP value to a value yet closer to the first QP value or equal to the first QP value itself. As a result, in this modified example, the amount of coding for the cuQpDelta is further reduced. Further, in this case, the inverse quantizing unit 24 reconstructs the orthogonal transform coefficient by inverse-quantizing the TU whose orthogonal transform coefficient value has been replaced in accordance with the second QP value, and the inverse orthogonal transform unit 25 calculates the prediction error signal rᵢⱼ by inverse-orthogonal transforming the reconstructed orthogonal transform coefficient. Then, the adder unit 26 generates the reference block by using the calculated rᵢⱼ. In the intra-predictive coding mode, the prediction block is generated based on the pixel value of the reference block adjacent to the TU to be encoded. As a result, if the pixel value of the reference block changes, the pixel value of the prediction block generated in the intra-predictive coding mode for the adjacent TU also changes. Therefore, when the CU containing the TU whose quantized orthogonal transform coefficient value is replaced is inter-predictive coded, the QP correcting unit 44 may determine the second QP so as to allow noise. On the other hand, when the CU containing that TU is intra-predictive coded, it is preferable that the QP correcting unit 44 determines the second QP within the range in which the prediction error signal rᵢⱼ is zero.

The QP correcting unit 44 supplies the second QP value to the quantizing unit 23, the inverse quantizing unit 24, and the deblocking filter unit 27. The QP correcting unit 44 further supplies the second QP value as the encoded data to the splicing unit 12. The splicing unit 12 entropy-codes the second QP value and the cuQpDelta calculated based on the second QP value in the QG that follows the QG containing the TU for which the second QP value was used.

The quantizing unit 23 and the inverse quantizing unit 24, using the second QP instead of the first QP, perform quantization and inverse quantization on any TU remaining to be processed and belonging to the same QG as the TU whose orthogonal transform coefficient value has been replaced. This is because the QP can be communicated only once for each QG to the video decoding apparatus, so that the video decoding apparatus performs inverse quantization on any TU remaining within the QG by using the second QP. Therefore, in the video encoding apparatus 1 also, quantization and inverse quantization are performed on any TU remaining within the QG by using the second QP. Similarly, the deblocking filter unit 27 determines the strength of the deblocking filter based on the second QP, and applies a deblocking filter to the first CU in the CTU row. The video encoding apparatus 1 can apply the same deblocking filter as the deblocking filter to be applied in the video decoding apparatus.

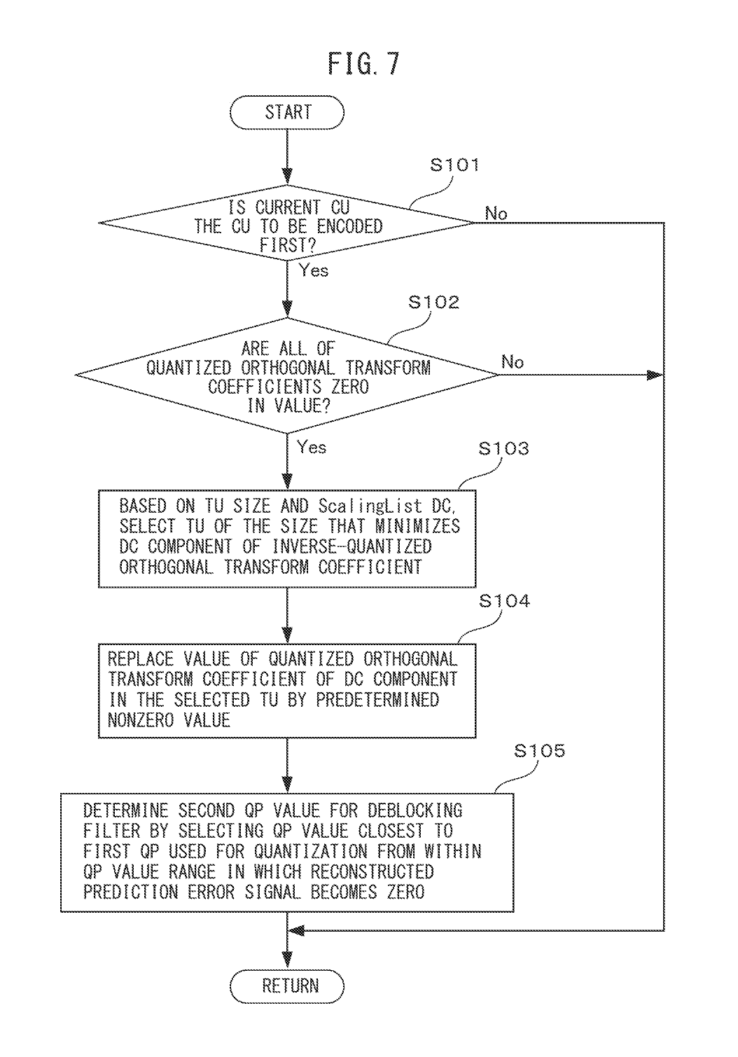

FIG. 7 is an operation flowchart illustrating the coefficient correction process performed by the coefficient correcting unit 32. The decision unit 41 makes a decision as to whether the current CU is the CU to be encoded first in the CTU row (step S101). If the current CU is not the CU to be encoded first in the CTU row (No in step S101), the coefficient correcting unit 32 terminates the coefficient correction process.

On the other hand, if the current CU is the CU to be encoded first in the CTU row (Yes in step S101), the decision unit 41 then makes a decision as to whether all the quantized orthogonal transform coefficients within the current CU are zero in value or not (step S102). If any one of the quantized orthogonal transform coefficients within the current CU has a nonzero value (No in step S102), the coefficient correcting unit 32 terminates the coefficient correction process.

On the other hand, if all the quantized orthogonal transform coefficients within the current CU are zero in value (Yes in step S102), the decision unit 41 decides that one of the quantized orthogonal transform coefficients within the current CU is to be corrected. Then, based on the size of the TU and the DC component value scalingListDC in the ScalingList corresponding to the TU, the TU selecting unit 42 selects the TU of the size that minimizes the DC component of the inverse-quantized orthogonal transform coefficient as the TU whose coefficient is to be corrected (step S103).

The replacing unit 43 replaces the value of the quantized orthogonal transform coefficient of the DC component in the selected TU by a predetermined nonzero value (step S104). Then, the replacing unit 43 supplies the quantized orthogonal transform coefficients of the TUs within the current CU, including the quantized orthogonal transform coefficient whose value has been replaced, to the splicing unit 12.

The QP correcting unit 44 determines the second QP by selecting a value closest to the first QP used for the quantization of the current CU from within the range of QP values in which the prediction error signal obtained by inverse-quantizing and inverse-orthogonal transforming the TU having the quantized orthogonal transform coefficient whose value has been replaced becomes zero (step S105). Then, the QP correcting unit 44 supplies the second QP value to the splicing unit 12, the quantizing unit 23, the inverse quantizing unit 24, and the deblocking filter unit 27. After that, the coefficient correcting unit 32 terminates the coefficient correction process.

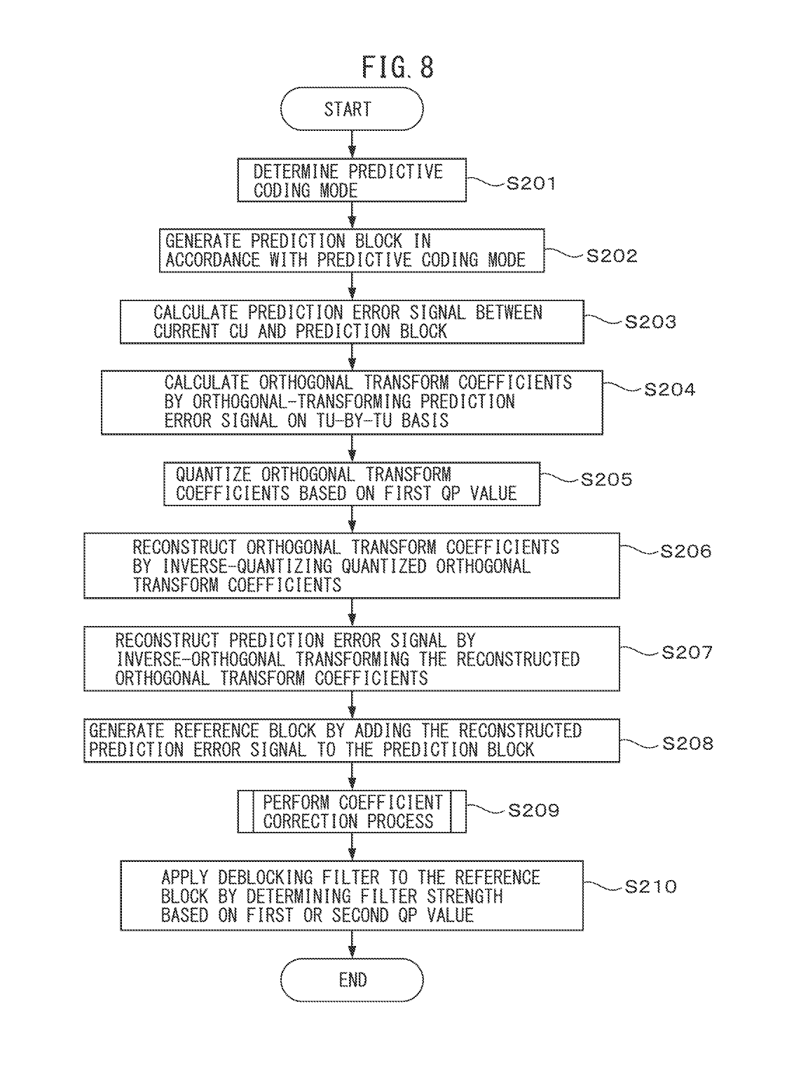

FIG. 8 is an operation flowchart illustrating the video encoding process performed by the video encoding apparatus 1. The video encoding apparatus 1 performs the video encoding process on a CU-by-CU basis.

The prediction mode determining unit 30 determines the predictive coding mode for the current CU (step S201). The prediction block generating unit 31 generates the prediction block in accordance with the determined predictive coding mode (step S202).

The prediction error calculating unit 21 calculates the prediction error signal between the current CU and the prediction block (step S203). The orthogonal transform unit 22 calculates orthogonal transform coefficients by orthogonal-transforming the prediction error signal on a TU-by-TU basis (step S204). The quantizing unit 23 calculates quantized orthogonal transform coefficients by quantizing the orthogonal transform coefficients with the quantization step size determined based on the first QP value (step S205).

The inverse quantizing unit 24 reconstructs the orthogonal transform coefficients by inverse-quantizing the quantized orthogonal transform coefficients (step S206). The inverse orthogonal transform unit 25 reconstructs the prediction error signal by inverse-orthogonal transforming the reconstructed orthogonal transform coefficients (step S207). The adder unit 26 generates the reference block by adding the reconstructed prediction error signal to the prediction block, and stores the reference block in the storage unit 28 (step S208).

On the other hand, the coefficient correcting unit 32 performs the coefficient correction process on the quantized coefficients (step S209). The deblocking filter unit 27 applies a deblocking filter to the reference block by determining the filter strength based on the first QP value or on the second QP value selected in accordance with the coefficient correction process (step S210). Then, the video encoding apparatus 1 terminates the video encoding process for one CU.

As has been described above, when encoding each picture on a CTU-row-by-CTU-row basis, if all the quantized orthogonal transform coefficients contained in the CU to be encoded first in a given CTU row are zero in value, the video encoding apparatus replaces the value of one of the quantized orthogonal transform coefficients by a predetermined nonzero value. By so doing, the video encoding apparatus can perform the encoding process in parallel fashion on a CTU row basis while eliminating the dependence between the CTU rows when applying the deblocking filtering. Furthermore, in the video encoding apparatus, the TU whose quantized orthogonal transform coefficient value is to be replaced is selected in such a manner as to reduce the noise associated with the replacement. Then, in the video encoding apparatus, the second QP value based on which to determine the strength of the deblocking filter for the first CU containing the TU whose coefficient value has been replaced is set to a value as close as possible to the QP value used for the quantization of that CU. In this way, the video encoding apparatus suppresses any increase in the amount of coding needed for encoding the QP value. Furthermore, the video encoding apparatus prevents the second QP value from becoming a very small value, and thereby prevents the amount of coding from increasing because of an occurrence in which the values of the quantized orthogonal transform coefficients of other CUs within the same QG as the first CU do not become small enough.

A video encoding apparatus according to a second embodiment will be described below. When all the quantized orthogonal transform coefficients contained in the first CU in a given CTU row are zero in value, the video encoding apparatus according of the second embodiment calculates the coding cost, i.e., an estimate of the amount of coding, for each possible combination of the TU partitioning pattern, the position of the TU whose orthogonal transform coefficient is to be corrected, and the candidate value of the second QP. Then, the video encoding apparatus corrects the quantized orthogonal transform coefficient in accordance with the combination that minimizes the coding cost.

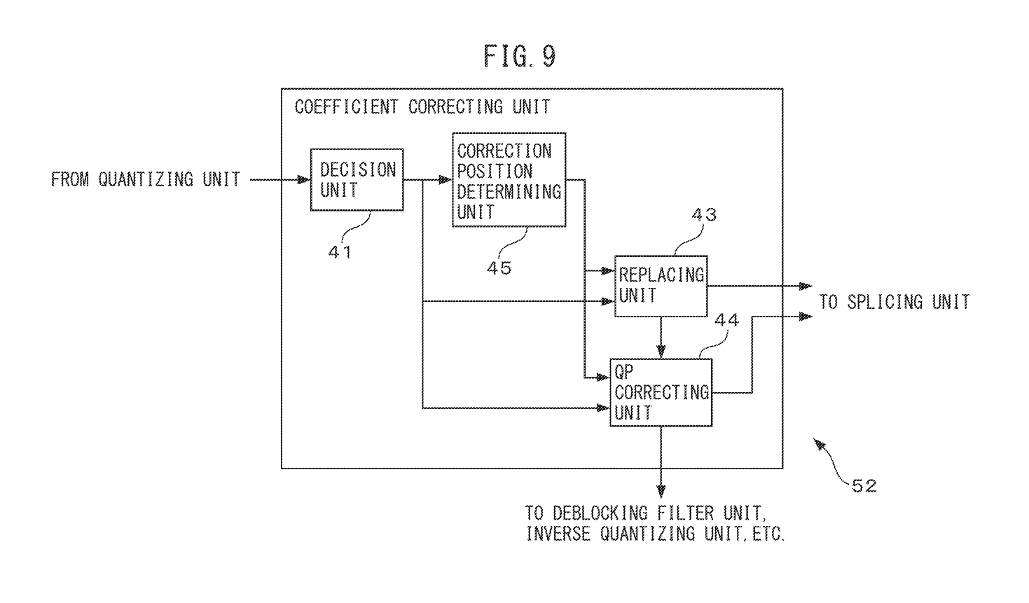

FIG. 9 is a diagram illustrating the configuration of a coefficient correcting unit 52 according to the second embodiment. The coefficient correcting unit 52 includes a decision unit 41, a correction position determining unit 45, a replacing unit 43, and a QP correcting unit 44. The video encoding apparatus according of the second embodiment differs from the video encoding apparatus according of the first embodiment in that the coefficient correcting unit 52 includes the correction position determining unit 45 in place of the TU selecting unit 42. The following therefore describes the correction position determining unit 45 and its related parts. For the other component elements of the video encoding apparatus, refer to the description earlier given of the corresponding component elements of the video encoding apparatus of the first embodiment.

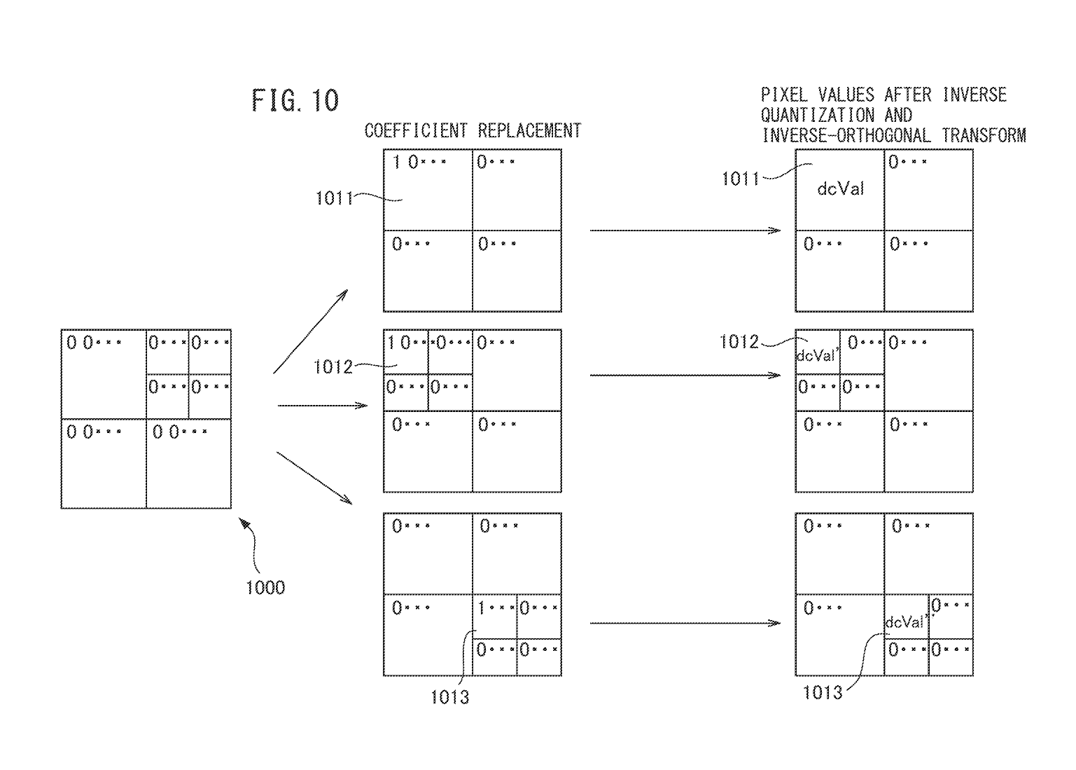

FIG. 10 is a conceptual diagram illustrating how the coefficient correction process is performed by the coefficient correcting unit 52 according to the second embodiment. The coefficient correcting unit 52 partitions the CU 1000, which is the first CU to be encoded and all of whose quantized coefficients are zero in value, into TUs in accordance with each applicable TU partitioning pattern. For each TU partitioning pattern, the coefficient correcting unit 52 replaces the quantized coefficient of one of the TUs set in accordance with the TU partitioning pattern (TUs 1011 to 1013 in FIG. 10) by a predetermined nonzero value, for example, 1. Then, the coefficient correcting unit 52 calculates the coding cost that would arise if the TU whose coefficient was corrected (one of TUs 1011 to 1013 in FIG. 10) were inverse-quantized using the candidate value of the second QP. Then, the coefficient correcting unit 52 identifies the combination that minimizes the coding cost among the various combinations of the TU partitioning pattern, the position of the TU whose quantized coefficient is to be corrected, and the candidate value of the second QP.

For the CU that is to be encoded first in the CTU row and in which one of the quantized coefficients is to be corrected, the correction position determining unit 45 calculates the coding cost for each possible combination of the TU partitioning pattern candidate, the position of the TU whose quantized orthogonal transform coefficient is to be corrected, and the QP value candidate. For example, the correction position determining unit 45 selects the first QP used for the quantization of the current CU and each QP value contained in the QP value range in Table 1 for the corresponding TU size sequentially as the candidate value of the second QP. Further, the correction position determining unit 45 takes each of the TU partitioning patterns defined in HEVC as the TU partitioning pattern candidate.

In the present embodiment, as in the first embodiment, the quantized orthogonal transform coefficient whose value is to be replaced is the coefficient representing the DC component. Further, in the calculation of the coding cost, if the value of the quantized orthogonal transform coefficient is replaced by the same absolute value for all possible combinations, the magnitude of the coding cost is the same for any combination whatever the absolute value of the quantized orthogonal transform coefficient after the replacement. In view of this, the quantized orthogonal transform coefficient after the replacement need only be either 1 or −1. Therefore, the correction position determining unit 45 calculates the coding cost for each combination by setting the quantized orthogonal transform coefficient of the DC component to 1 or −1 and the quantized orthogonal transform coefficients of other frequency components to 0.

The coding cost C is calculated from the following equation in accordance with Lagrange's undetermined multiplier method.

C=Coding Error+λ·(number of bits) (5)

where λ is the undetermined multiplier.

The coding error in equation (5) can be calculated in the following manner.

In the CU of N×N pixels, let qp denote the candidate value for the attention QP, and k denote the quantized orthogonal transform coefficient representing the DC component; then, the prediction error signal value rᵢⱼ obtained by inverse quantization and inverse orthogonal transform is the same regardless of the pixel position. The correction position determining unit 45 can calculate dcVal(N,k,qp) in accordance with the equations (3) and (4).

The coding error can be expressed as the sum of the squares of the pixel-by-pixel errors between the original picture and the decoded picture. In view of this, consider the decoded CU when the quantized orthogonal transform of the DC component is corrected. For any given pixel position i, the pixel value in the prediction block is denoted by pred(i); then, the corresponding pixel value ldec(i) in the decoded CU is expressed by the following equation.

ldec(i)=pred(i)+dcval(N,k,qp) (6)

Accordingly, when each pixel value in the original CU of N×N pixels is denoted by org(i), and the prediction error signal by diff(i)=org(i)−pred(i), the sum of the squares of the errors of the pixel values ldec(i) in the decoded CU is expressed by the following equation.

$$\begin{matrix}Coding error = \sum {( org ( i ) - 1 dec ( i ) )}^{2} \\ = \sum {( org ( i ) - pred ( i ) - dcval ( N , k , qp ) )}^{2} \\ = \sum \{ {diff ( i )}^{2} \} - 2 \cdot dcval ( N , k , qp ) \sum diff ( i ) + \\ {dcval ( N , k , qp )}^{2} \cdot {N}^{2}\end{matrix} \qquad ( 7 )$$

That is, by calculating the sum of the squares of the prediction error signals, Σ{diff(i)²}, and the sum of the prediction errors, Σdiff(i), the correction position determining unit 45 can calculate the coding errors for the case of k=±1, ±2, and so on without having to perform the inverse quantization and inverse orthogonal transform.

Further, as earlier described, the correction position determining unit 45 need only calculate the coding cost for k=±1 in order to determine the combination that minimizes the coding cost among the various combinations of the TU partitioning pattern, the position of the TU whose quantized orthogonal transform coefficient is to be corrected, and the QP value candidate. Therefore, if Σ{diff(i)²} and Σdiff(i) are calculated in advance, the correction position determining unit 45 can reduce the amount of computation needed for the calculation of the coding error. Furthermore, since Σdiff(i) is calculated by the calculation of the DC component in the orthogonal transform, the correction position determining unit 45 may receive Σdiff(i) from the orthogonal transform unit 22.

When the CU is inter-predictive coded, the value of Σ{diff(i)²} is the same regardless of the TU partitioning pattern. This means that even if Σ{diff(i)²} is regarded as 0, the result of the comparison of the coding cost for each combination does not change. Therefore, when the CU is inter-predictive coded, the correction position determining unit 45 may not need to calculate Σ{diff(i)²} but may regard it as 0. In this case, the amount of computation for the coding error is almost negligible.

As is apparent from equation (6), the coding error is smaller when the sign of dcval(N,k,qp) and the sign of Σdiff(i) are the same than when they are different, because the sign of the second term on the right-hand side becomes negative. Therefore, considering the equations (3) and (4) for calculating dcVal(N,k,qp), the correction position determining unit 45 need only calculate the coding cost for

k=1 when Σdiff(i)≧0, and

k=−1 when Σdiff(i)<0

As described above, the correction position determining unit 45 calculates the coding cost for each possible combination of the TU partitioning pattern candidate, the position of the TU whose quantized orthogonal transform coefficient is to be corrected, and the QP value candidate. Then, the correction position determining unit 45 determines the combination that minimizes the coding cost. The correction position determining unit 45 notifies the replacing unit 43 of the TU partitioning pattern, the position of the TU whose quantized orthogonal transform coefficient is to be corrected, and the value of the corresponding k that are contained in the combination that minimizes the coding cost. Further, the correction position determining unit 45 notifies the QP correcting unit 44 of the QP value contained in the combination that minimizes the coding cost.

Based on the TU partitioning pattern and the position of the TU, the replacing unit 43 identifies from within the first CU the TU whose quantized orthogonal transform coefficient is to be corrected, and replaces the DC component of that TU by the corresponding k (that is, 1 or −1). Then, the replacing unit 43 supplies the TU partitioning pattern and the values of the quantized orthogonal transform coefficients in the first CU as the encoded data to the splicing unit 12.

The QP correcting unit 44 takes the received QP value as the second QP for the QG to which the first CU belongs. Then, the QP correcting unit 44 supplies the second QP value to the quantizing unit 23, the inverse quantizing unit 24, and the deblocking filter unit 27. The QP correcting unit 44 further supplies the second QP value as the encoded data to the splicing unit 12.

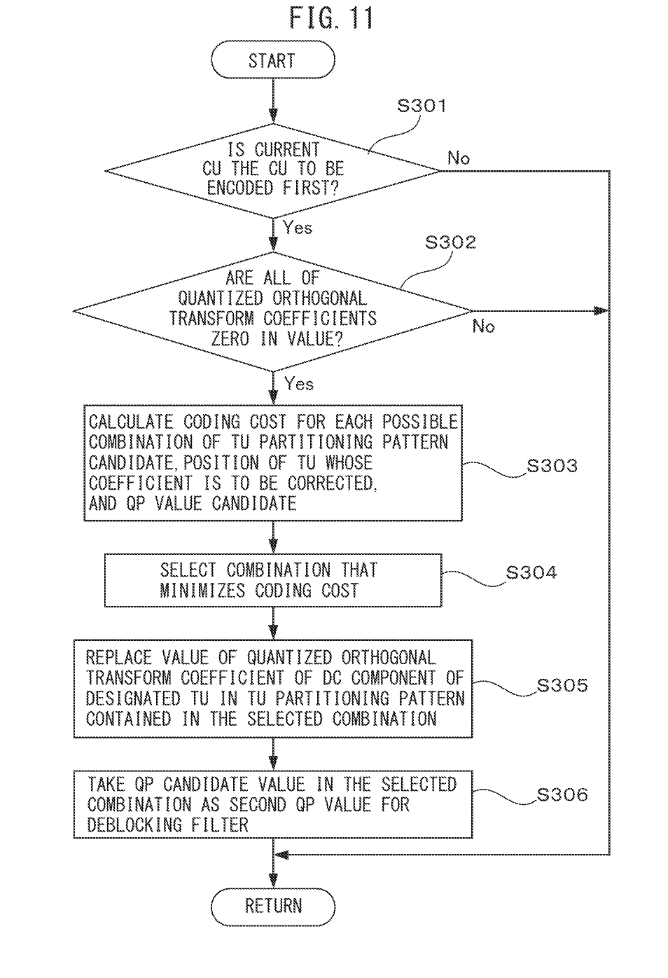

FIG. 11 is an operation flowchart illustrating the coefficient correction process performed in the video encoding apparatus according to the second embodiment. The decision unit 41 makes a decision as to whether the current CU is the CU to be encoded first in the CTU row (step S301). If the current CU is not the CU to be encoded first in the CTU row (No in step S301), the coefficient correcting unit 32 terminates the coefficient correction process.

On the other hand, if the current CU is the CU to be encoded first in the CTU row (Yes in step S301), the decision unit 41 then makes a decision as to whether all the quantized orthogonal transform coefficients within the current CU are zero in value or not (step S302). If any one of the quantized orthogonal transform coefficients within the current CU has a nonzero value (No in step S302), the coefficient correcting unit 32 terminates the coefficient correction process.

On the other hand, if all the quantized orthogonal transform coefficients within the current CU are zero in value (Yes in step S302), the decision unit 41 decides that one of the quantized orthogonal transform coefficients within the current CU is to be corrected. In this case, the correction position determining unit 45 calculates the coding cost for each possible combination of the TU partitioning pattern candidate, the position of the TU whose quantized coefficient is to be corrected, and the QP value candidate (step S303). Then, the correction position determining unit 45 determines the combination that minimizes the coding cost (step S304).

The replacing unit 43 replaces the value of the quantized orthogonal transform coefficient of the DC component of the designated TU in the TU partitioning pattern contained in the selected combination by a predetermined nonzero value (step S305). Then, the replacing unit 43 supplies the quantized orthogonal transform coefficients of the TUs within the current CU, including the quantized orthogonal transform coefficient whose value has been replaced, to the splicing unit 12.

The QP correcting unit 44 takes the QP candidate value contained in the selected combination as the second QP value (step S306). Then, the QP correcting unit 44 supplies the second QP value to the splicing unit 12, the quantizing unit 23, the inverse quantizing unit 24, and the deblocking filter unit 27. After that, the coefficient correcting unit 52 terminates the coefficient correction process.

As has been described above, when correcting the designated orthogonal transform coefficient contained in the CU to be encoded first, the video encoding apparatus of the second embodiment calculates the coding cost for each possible combination of the TU partitioning pattern, the position of the TU whose quantized orthogonal transform coefficient is to be corrected, and the QP value after the correction. Then, from among the various combinations of the TU partitioning pattern, the position of the TU whose quantized orthogonal transform coefficient is to be corrected, and the QP value after the correction, the video encoding apparatus determines the combination that minimizes the coding cost associated with the correction of the quantized orthogonal transform coefficient. In this way, the video encoding apparatus can suppress any increase in the coding cost associated with the correction of the quantized orthogonal transform coefficient, while eliminating the dependence between the CTU rows when applying the deblocking filtering in the encoding process performed on a CTU-row-by-CTU-row basis.

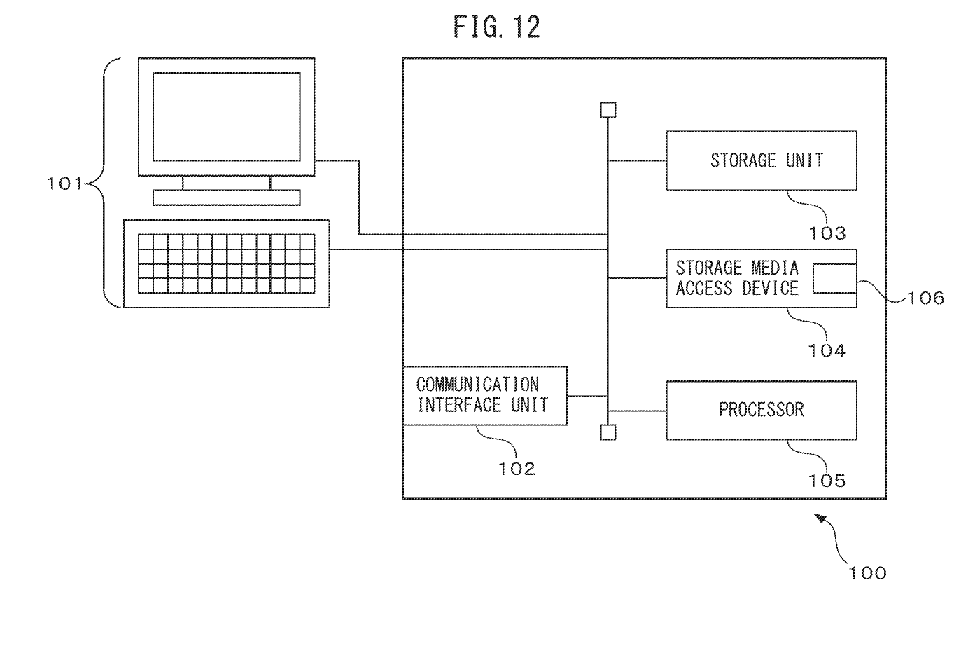

FIG. 12 is a diagram illustrating the configuration of a computer that operates as the video encoding apparatus by executing a computer program for implementing the functions of the various units constituting the video encoding apparatus according to any one of the above embodiments or their modified examples.

The computer 100 includes a user interface unit 101, a communication interface unit 102, a storage unit 103, a storage media access device 104, and a processor 105. The processor 105 is connected to the user interface unit 101, communication interface unit 102, storage unit 103, and storage media access device 104, for example, via a bus.

The user interface unit 101 includes, for example, an input device such as a keyboard and a mouse, and a display device such as a liquid crystal display. Alternatively, the user interface unit 101 may include a device, such as a touch panel display, into which an input device and a display device are integrated. The user interface unit 101 generates, for example, in response to a user operation, an operation signal for selecting the video data to be encoded, and supplies the operation signal to the processor 105.

The communication interface unit 102 may include a communication interface for connecting the computer 100 to a video data generating apparatus such as a video camera, and a control circuit for the communication interface. Such a communication interface may be, for example, a Universal Serial Bus (USB) interface.

Further, the communication interface unit 102 may include a communication interface for connecting to a communication network conforming to a communication standard such as the Ethernet (registered trademark), and a control circuit for the communication interface.

In this case, the communication interface unit 102 acquires video data to be encoded from another apparatus connected to the communication network, and passes the data to the processor 105. The communication interface unit 102 may receive encoded video data from the processor 105 and may transmit the data to another apparatus via the communication network.

The storage unit 103 includes, for example, a readable/writable semiconductor memory and a read-only semiconductor memory. The storage unit 103 stores a computer program for implementing the video encoding process to be executed on the processor 105, and also stores data generated as a result of or during the execution of the program.

The storage media access device 104 is a device that accesses a storage medium 106 such as a magnetic disk, a semiconductor memory card, or an optical storage medium. The storage media access device 104 accesses the storage medium 106 to read out, for example, the video encoding computer program to be executed on the processor 105, and passes the readout computer program to the processor 105.

The processor 105 generates the encoded video data by executing the video encoding computer program according to any one of the above embodiments or their modified examples. The processor 105 passes the encoded video data thus generated to the storage unit 103 for storing therein, or transmits the encoded video data to another apparatus via the communication interface unit 102.

A computer program executable on a processor to implement the functions of the various units constituting the video encoding apparatus 1 may be provided in the form recorded on a computer readable recording medium. The term “recording medium” here does not include a carrier wave.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of superiority and inferiority of the invention. Although the embodiments of the present invention have been described in detail, it should be understood that the various changes, substitutions, and alterations could be made hereto without departing from the spirit and scope of the invention.

What is claimed is:

1. A video encoding apparatus which divides a picture contained in video data into a plurality of blocks and encodes the picture on a block-row-by-block-row basis, comprising:
an orthogonal transform unit which, for each of a plurality of sub-blocks formed by partitioning each of the blocks, calculates an orthogonal transform coefficient by orthogonal-transforming a prediction error signal taken between the sub-block and a prediction block corresponding to the sub-block for each of transform units formed by partitioning the sub-block;
a quantizing unit which, for each of the plurality of sub-blocks, calculates a quantized orthogonal transform coefficient by quantizing the orthogonal transform coefficient in accordance with a first quantization parameter that defines a quantization step size;
an inverse quantizing unit which, for each of the plurality of sub-blocks, reconstructs the orthogonal transform coefficient by inverse-quantizing the quantized orthogonal transform coefficient by using the first quantization parameter;
an inverse orthogonal transform unit which, for each of the plurality of sub-blocks, reconstructs the prediction error signal by inverse-orthogonal transforming the reconstructed orthogonal transform coefficient;
an adder unit which, for each of the plurality of sub-blocks, reproduces the sub-block by adding each reconstructed prediction error signal to the value of the corresponding pixel of the corresponding prediction block;
a deblocking filter unit which, for each reproduced sub-block, when all the quantized orthogonal transform coefficients for the sub-block are zero in value, determines deblocking filter strength based on the first quantization parameter determined for another sub-block already encoded but, when any of the quantized orthogonal transform coefficients for the sub-block is nonzero in value, determines the deblocking filter strength based on the first quantization parameter determined for the sub-block, and applies deblocking filtering with the determined strength; and
a coefficient correcting unit which, when all the quantized orthogonal transform coefficients in a first sub-block of the plurality of sub-blocks that is to be encoded first in a row of the blocks are zero in value, selects from among the transform units contained in the first sub-block the transform unit that minimizes degradation of picture quality of the reproduced first sub-block or minimizes an increase in the amount of coding of the first sub-block, and replaces the value of the quantized orthogonal transform coefficient of the selected transform unit by a predetermined nonzero value.

2. The video encoding apparatus according to claim 1, wherein when all the quantized orthogonal transform coefficients in the first sub-block are zero in value, the coefficient correcting unit selects the transform unit having the largest size among the transform units contained in the first sub-block, and replaces the value of the quantized orthogonal transform coefficient of the selected transform unit by the predetermined value.

3. The video encoding apparatus according to claim 1, wherein when all the quantized orthogonal transform coefficients in the first sub-block are zero in value, the coefficient correcting unit sets a second quantization parameter by selecting a value closest to the first quantization parameter from within a range of quantization parameter values in which the prediction error signal obtained by inverse-quantizing and inverse-orthogonal transforming the transform unit containing the quantized orthogonal transform coefficient whose value has been replaced by the predetermined value becomes zero, and wherein
the deblocking filter unit determines the deblocking filter strength for the first sub-block based on the second quantization parameter.

4. The video encoding apparatus according to claim 1, wherein when all the quantized orthogonal transform coefficients in the first sub-block are zero in value, for each possible combination of a transform unit partitioning pattern to be applied to the first sub-block, the position of the transform unit whose quantized orthogonal transform coefficient value is to be replaced by the predetermined value, and a candidate value for the quantization parameter, the coefficient correcting unit calculates an estimated amount of coding that would occur if any one of the quantized orthogonal transform coefficients of any one of the transform units were replaced by the predetermined value and, in accordance with the combination that minimizes the estimated amount, determines the transform unit partitioning pattern, the transform unit whose quantized orthogonal transform coefficient value is to be replaced by the predetermined value, and a second quantization parameter based on which to determine the deblocking filter strength for the first sub-block.

5. The video encoding apparatus according to claim 4, wherein when all the quantized orthogonal transform coefficients in the first sub-block are zero in value, the coefficient correcting unit sets the candidate value for the quantization parameter from within a range of quantization parameter values in which the prediction error signal obtained by inverse-quantizing and inverse-orthogonal transforming the transform unit containing the quantized orthogonal transform coefficient whose value has been replaced by the predetermined value becomes zero.

6. The video encoding apparatus according to claim 3, wherein when the second quantization parameter has been set for the first sub-block, the quantizing unit quantizes, using the second quantization parameter, the orthogonal transform coefficient of each of the plurality of sub-blocks that belongs to a range within which the same quantization parameter as the quantization parameter applied to the first sub-block is applied.

7. A video encoding method for dividing a picture contained in video data into a plurality of blocks and for encoding the picture on a block-row-by-block-row basis, comprising:
for each of a plurality of sub-blocks formed by partitioning each of the blocks, calculating an orthogonal transform coefficient by orthogonal-transforming a prediction error signal taken between the sub-block and a prediction block corresponding to the sub-block for each of transform units formed by partitioning the sub-block;
for each of the plurality of sub-blocks, calculating a quantized orthogonal transform coefficient by quantizing the orthogonal transform coefficient in accordance with a first quantization parameter that defines a quantization step size;
for each of the plurality of sub-blocks, reconstructing the orthogonal transform coefficient by inverse-quantizing the quantized orthogonal transform coefficient by using the first quantization parameter;
for each of the plurality of sub-blocks, reconstructing the prediction error signal by inverse-orthogonal transforming the reconstructed orthogonal transform coefficient;
for each of the plurality of sub-blocks, reproducing the sub-block by adding each reconstructed prediction error signal to the value of the corresponding pixel of the corresponding prediction block;
for each reproduced sub-block, when all the quantized orthogonal transform coefficients for the sub-block are zero in value, determining deblocking filter strength based on the first quantization parameter determined for another sub-block already encoded but, when any of the quantized orthogonal transform coefficients for the sub-block is nonzero in value, determining the deblocking filter strength based on the first quantization parameter determined for the sub-block;
applying deblocking filtering with the determined strength; and
when all the quantized orthogonal transform coefficients in a first sub-block of the plurality of sub-blocks that is to be encoded first in a row of the blocks are zero in value, selecting from among the transform units contained in the first sub-block the transform unit that minimizes degradation of picture quality of the reproduced first sub-block or minimizes an increase in the amount of coding of the first sub-block, and replacing the value of the quantized orthogonal transform coefficient of the selected transform unit by a predetermined nonzero value.

8. The video encoding method according to claim 7, wherein when all the quantized orthogonal transform coefficients in the first sub-block are zero in value, the selecting the transform unit selects the transform unit having the largest size among the transform units contained in the first sub-block.

9. The video encoding method according to claim 7, further comprising:
when all the quantized orthogonal transform coefficients in the first sub-block are zero in value, setting a second quantization parameter by selecting a value closest to the first quantization parameter from within a range of quantization parameter values in which the prediction error signal obtained by inverse-quantizing and inverse-orthogonal transforming the transform unit containing the quantized orthogonal transform coefficient whose value has been replaced by the predetermined value becomes zero, and wherein
the applying deblocking filtering determines the deblocking filter strength for the first sub-block based on the second quantization parameter.

10. The video encoding method according to claim 7, further comprising:
when all the quantized orthogonal transform coefficients in the first sub-block are zero in value, for each possible combination of a transform unit partitioning pattern to be applied to the first sub-block, the position of the transform unit whose quantized orthogonal transform coefficient value is to be replaced by the predetermined value, and a candidate value for the quantization parameter, calculating an estimated amount of coding that would occur if any one of the quantized orthogonal transform coefficients of any one of the transform units were replaced by the predetermined value and, in accordance with the combination that minimizes the estimated amount; and
determining the transform unit partitioning pattern, the transform unit whose quantized orthogonal transform coefficient value is to be replaced by the predetermined value, and a second quantization parameter based on which to determine the deblocking filter strength for the first sub-block.

11. The video encoding method according to claim 10, wherein when all the quantized orthogonal transform coefficients in the first sub-block are zero in value, the calculating the estimated amount of coding sets the candidate value for the quantization parameter from within a range of quantization parameter values in which the prediction error signal obtained by inverse-quantizing and inverse-orthogonal transforming the transform unit containing the quantized orthogonal transform coefficient whose value has been replaced by the predetermined value becomes zero.

12. The video encoding method according to claim 9, wherein when the second quantization parameter has been set for the first sub-block, the calculating the quantized orthogonal transform coefficient quantizes, using the second quantization parameter, the orthogonal transform coefficient of each of the plurality of sub-blocks that belongs to a range within which the same quantization parameter as the quantization parameter applied to the first sub-block is applied.

13. A non-transitory computer-readable recording medium having recorded thereon a video encoding computer program that causes a computer to execute dividing a picture contained in video data into a plurality of blocks and encodes the picture on a block-row-by-block-row basis, the video encoding computer program causes the computer to execute a process comprising:
for each of a plurality of sub-blocks formed by partitioning each of the blocks, calculating an orthogonal transform coefficient by orthogonal-transforming a prediction error signal taken between the sub-block and a prediction block corresponding to the sub-block for each of transform units formed by partitioning the sub-block;
for each of the plurality of sub-blocks, calculating a quantized orthogonal transform coefficient by quantizing the orthogonal transform coefficient in accordance with a first quantization parameter that defines a quantization step size;
for each of the plurality of sub-blocks, reconstructing the orthogonal transform coefficient by inverse-quantizing the quantized orthogonal transform coefficient by using the first quantization parameter;
for each of the plurality of sub-blocks, reconstructing the prediction error signal by inverse-orthogonal transforming the reconstructed orthogonal transform coefficient;
for each of the plurality of sub-blocks, reproducing the sub-block by adding each reconstructed prediction error signal to the value of the corresponding pixel of the corresponding prediction block;
for each reproduced sub-block, when all the quantized orthogonal transform coefficients for the sub-block are zero in value, determining deblocking filter strength based on the first quantization parameter determined for another sub-block already encoded but, when any of the quantized orthogonal transform coefficients for the sub-block is nonzero in value, determining the deblocking filter strength based on the first quantization parameter determined for the sub-block;
applying deblocking filtering with the determined strength; and
when all the quantized orthogonal transform coefficients in a first sub-block of the plurality of sub-blocks that is to be encoded first in a row of the blocks are zero in value, selecting from among the transform units contained in the first sub-block the transform unit that minimizes degradation of picture quality of the reproduced first sub-block or minimizes an increase in the amount of coding of the first sub-block, and replacing the value of the quantized orthogonal transform coefficient of the selected transform unit by a predetermined nonzero value.
